(19) United States
(12) Patent Application Publication
(10) Pub. No.: US 2026/0353063 A1
(43) Pub. Date: Nov. 5, 2026

(54) VIRTUAL DEVICE ECOSYSTEM TO IMPROVE HUMAN-ARTIFICIAL INTELLIGENCE INTERACTION

(71) Applicant: AT&T Intellectual Property I, L.P., Atlanta, GA (US)

(72) Inventors: Yupeng Jia, South Pasadena, CA (US); Hongyan Lei, Plano, TX (US); Venson Shaw, Kirkland, WA (US)

(73) Assignee: AT&T Intellectual Property I, L.P., Atlanta, GA (US)

(21) Appl. No.: 19/198,621

(22) Filed: May 5, 2025

(51) Int. Cl. H04W 8/18; H04L 41/16; H04W 12/06; H04W 12/71

(52) U.S. Cl. CPC H04W 8/183; H04L 41/16; H04W 12/06; H04W 12/71

(57) ABSTRACT

Aspects of the subject disclosure may include, for example, generating, on a physical device, a plurality of virtual device identities, each virtual device identity comprising a virtual international mobile equipment identity (vIMEI) that is matching a physical international mobile equipment identity (pIMEI) of the physical device, instantiating one or more virtual subscribers, each respective virtual subscriber associated with a respective virtual device identity of the plurality of virtual device identities, and associating each virtual device identity with a corresponding set of operational parameters, the set of operational parameters associated with a particular task of a virtual subscriber associated with the virtual device identity. Other embodiments are disclosed.

### FIELD OF THE DISCLOSURE

The subject disclosure relates to telecommunications and information technology, specifically to virtual device ecosystems and machine learning integration for improved device management and interaction.

### BACKGROUND

In today's fast-evolving technological landscape, users demand more flexible, efficient, and secure interactions with their devices. Current mobile and internet of things (IoT) ecosystems face significant limitations in terms of device communication, security, and user productivity. Traditional device identification methods, such as physical identifiers for devices, lack the flexibility needed for dynamic and scalable device management. Moreover, the inability to perform real-time, low-power AI processing hampers the efficiency and responsiveness of smart devices.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system and method for creating and managing virtual International Mobile Equipment Identities (vIMEIs) on a physical device, allowing for multiple virtual device identities to be instantiated and operated independently. These vIMEIs enable the device to perform specific tasks, such as communication and AI-based decision-making, by partitioning the device's resources and capabilities. In embodiments, the system also integrates TinyML for efficient, low-power processing and supports a dedicated app store for applications tailored to virtual devices, enhancing flexibility and functionality. Other embodiments are described in the subject disclosure.

One or more aspects of the subject disclosure include storing a physical International Mobile Equipment Identity (physical IMEI), wherein the physical IMEI has associated therewith a set of capabilities associated with functions of the device, creating one or more virtual International Mobile Equipment Identities (virtual IMEIs) as replicas of the physical IMEI, wherein each virtual IMEI of the one or more virtual IMEIs has associated therewith a subset of the set of capabilities associated with functions of the device, performing at least some of the functions of the device according to the physical IMEI, and performing at least one of the functions of the device according to a virtual IMEI of the one or more virtual IMEIs.

One or more aspects of the subject disclosure include generating, on a physical device, a plurality of virtual device identities, each virtual device identity comprising a virtual international mobile equipment identity (vIMEI) that is matching a physical international mobile equipment identity (pIMEI) of the physical device, instantiating one or more virtual subscribers, each respective virtual subscriber associated with a respective virtual device identity of the plurality of virtual device identities, and associating each virtual device identity with a corresponding set of operational parameters, the set of operational parameters associated with a particular task of a virtual subscriber associated with the virtual device identity.

One or more aspects of the subject disclosure include creating a plurality of virtual device identities on a physical device, forming generated virtual identities, wherein each virtual device identity comprises a virtual international mobile equipment identity (vIMEI) based on a physical international mobile equipment identity (pIMEI) of the physical device, receiving an application specific to a virtual device identity of the plurality of virtual device identities from a dedicated virtual device application store, wherein the application enables performance of specific functions by virtual devices associated with the virtual device identity, and instantiating a generated virtual identity, wherein the instantiating the generated virtual identity comprises instantiating the generated virtual identity according to the application for performance of the specific functions by the generated virtual identity.

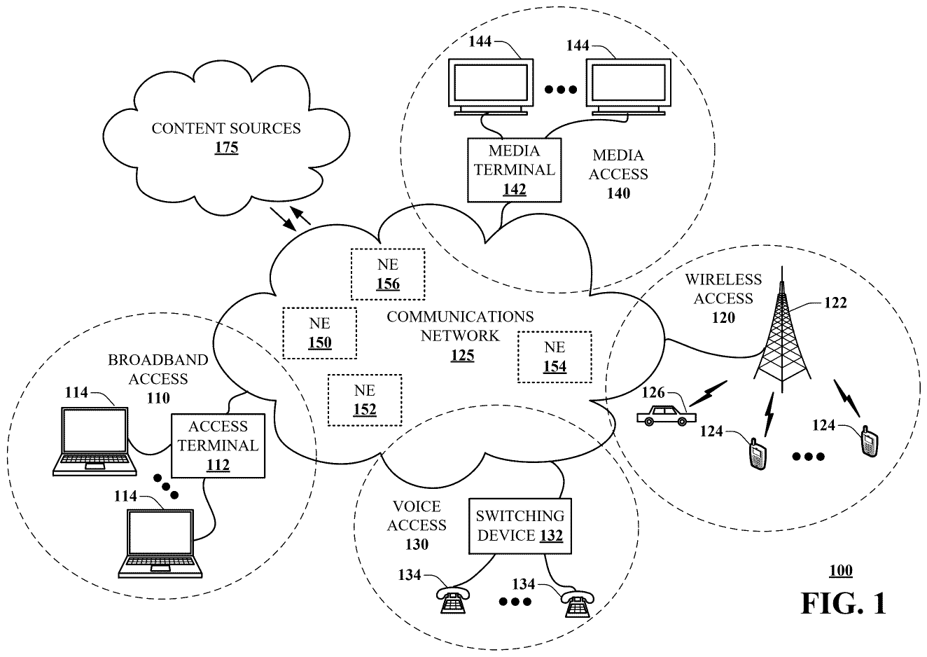

Referring now to FIG. 1, a block diagram is shown illustrating an example, non-limiting embodiment of a system 100 in accordance with various aspects described herein. For example, system 100 can facilitate in whole or in part creation and management of virtual IMEIs based on a physical IMEI in a device accessing a communications network. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In the current technological landscape, users have found a need for more flexible, efficient, and secure interactions with their devices. This includes autonomous operation of devices and easy communication among such devices. Current mobile and internet of things (IoT) ecosystems face significant limitations in terms of device communication, security, and user productivity.

Traditional device identification methods lack the flexibility needed for dynamic and scalable device management. One example of a conventional device identification method is a physical International Mobile Equipment Identity (IMEI). An IMEI is a unique identifier on a mobile network for a device such as mobile devices 124 including mobile handsets and wearable devices, vehicle 126, and IoT devices. The IMEI identifies the device, not the user or subscriber. Generally, a device may include a subscriber identity module (SIM) which identifies the subscriber as well as provisioning information for a subscription for services on the device by a service provider or mobile network operator. The IMEI allows the mobile network to identify valid devices and distinguish between them.

In some embodiments, the IMEI includes a 15-digit number uniquely associated with the device. In one example, the 15-digit IMEI typically follows this format: AA-BBBBBB-CCCCCC-D, where AA corresponds to the Reporting Body Identifier and indicates the GSMA-approved group that allocated the Type Allocation Code (TAC), BBBBBB is the Type Allocation Code (TAC), which identifies the manufacturer and model of the device, CCCCCC is a Serial Number (SNR), or a unique serial number assigned by the manufacturer to each individual device, and D is a check Digit (CD), a single digit used to validate the entire IMEI number using a feature known as the Luhn algorithm. The Type Allocation Code identifies a particular model (and often revision) of wireless device for use on a wireless network. GSMA is the GSM Association, an industry standards group.

A primary purpose of the IMEI of a device is to uniquely identify a specific mobile device on a network. A Mobile Network Operator (MNO) uses the IMEI to verify that the mobile device is legitimate and authorized to use their network. The IMEI can be used for locating lost or stolen devices, or for disabling lost or stolen devices from network access. In an example, when a device tries to connect to a mobile network, the device transmits the IMEI over a radio link to the network with a request for access. The network checks the IMEI against its Equipment Identity Register (EIR) or similar information. This database contains lists of valid, stolen, or blacklisted devices, according to their associated IMEI. If the IMEI is valid and not blacklisted, the network allows the device to register and access its services, like making calls, sending texts, and using mobile data. In some network management applications, the MNO might use IMEI information to understand the types of devices on the network. This can indirectly influence how the MNO optimizes network services for different device capabilities.

The initial part of the IMEI, the Type Allocation Code (TAC), identifies the manufacturer and model of the device. While the IMEI itself doesn't activate features of the device, like the camera or Wi-Fi, the network and other systems can infer the device's capabilities based on its model identified by the TAC. For instance, knowing the model allows the network to understand if the device supports 4G LTE or Voice over LTE (VoLTE), which can influence the services offered. Further, an MNO may use the IMEI to check if a specific device is compatible with particular network technologies such as frequency bands, VoLTE support, etc. The IMEI helps determine if the device has the capability to use the network's specific features.

Some devices have the capability for a dual SIM or multiple SIMs. This may enable access to multiple mobility networks, for example. The SIMs may be physical devices or SIM cards that fit in slots on the device. Or the SIMs may be electronic SIMs or eSIMS that are stored in memory of the device. Each SIM slot or eSIM may have a unique IMEI. The IMEI and the SIM information are used to register with the network and access network services. Having two IMEI numbers allows the network to identify and track each connection independently, which is essential for the dual SIM functionality to work correctly.

A user of a mobile device is a subscriber to particular network services offered by the MNO. The subscription is provisioned to the subscriber's account which is consulted when the user seeks to access a service. When a service feature is provisioned, service is associated with the IMEI of the device. Then, when the service is accessed, the IMEI is used along with provisioning information to enable access to the service. However, the flexibility of the IMEI is limited because it is tied to a physical device and, to date, has been used for only limited purposes. This lack of flexibility for conventional communication devices creates a technical problem in that a single physical IMEI is assigned to the communication device but there is an increasing need to perform multiple functions simultaneously or independently. This has limited the use of all the many capabilities of such communication devices.

In addition to a lack of flexibility afforded by a conventional IMEI, the inability to perform real-time, low-power AI processing hampers the efficiency and responsiveness of smart devices, or devices that include some artificial intelligence or machine learning (AI/ML) capability. There is also a need for enhanced security measures to detect and respond to dangerous activities promptly. Additionally, existing solutions do not adequately support multitasking or provide a seamless user experience through virtual devices.

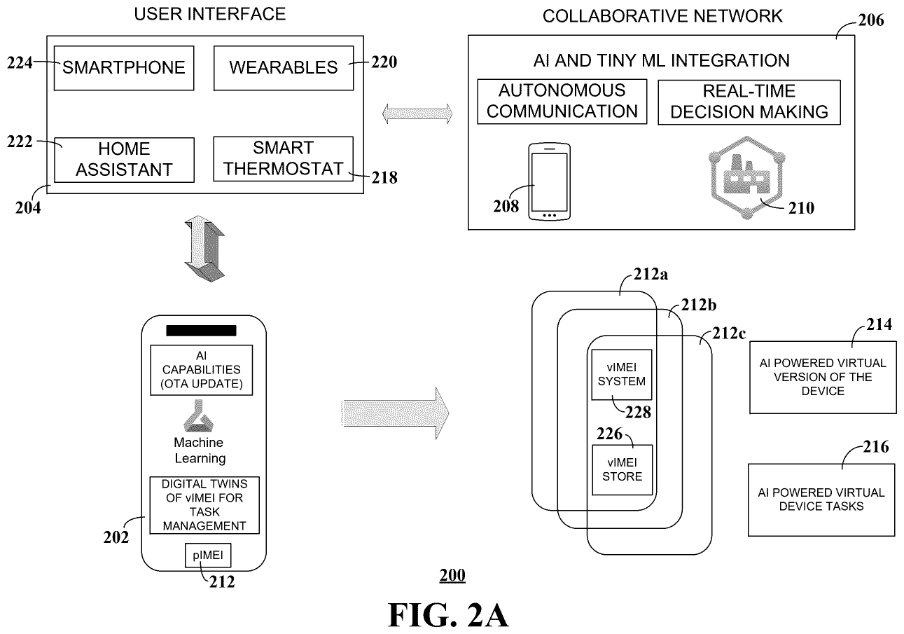

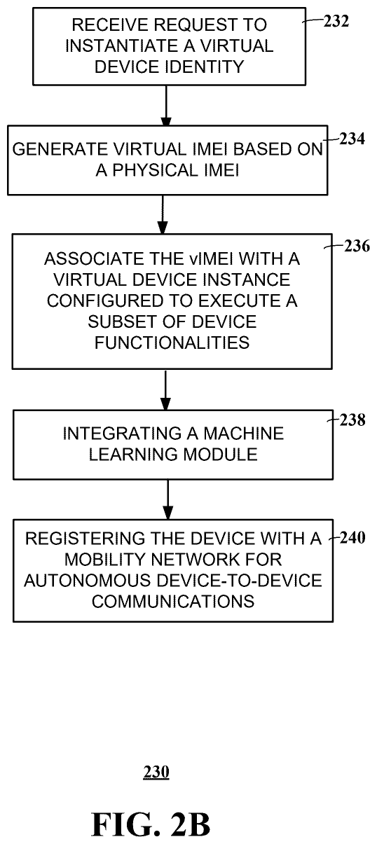

FIG. 2A is a block diagram illustrating an example, non-limiting embodiment of a system 200 functioning within the communication network of FIG. 1 in accordance with various aspects described herein. In FIG. 2A, the system 200 includes a device 202 having a user interface 204 that enables human control of one or more devices including the device 202. Further, the system 200 includes a collaborative network 206 of devices including, in this example, smartphone 208 and internet of things (IoT) device 210. The system 200 may include any suitable number of other devices and functionality.

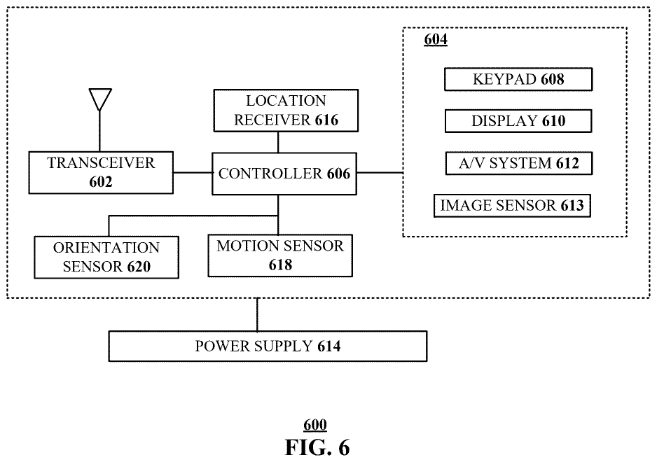

The device 202 may be implemented as any suitable device operable on a mobile communications network such as wireless access 120. In exemplary embodiments, the device 202 may includes a smartphone, a tablet computer, an IoT device or other similar device with radio communications capabilities. In some embodiments the device may be embodied as a communication device 600 as illustrated in FIG. 6. In general, the device 202 includes a radio transceiver for radio communications with a mobility network such as a fifth generation (5G), sixth generation (6G) or later cellular network, a Wi-Fi network, or similar network.

For registering with the mobility network, the device includes a physical International Mobile Equipment Identity (IMEI) 212. An IMEI is a unique identifier on a mobility network for a device such as the devices 202. The IMEI identifies the device, not the user or subscriber. Generally, a device such as device 202 may also include a subscriber identity module (SIM) which identifies the subscriber as well as provisioning information for a subscription for services on the device by a service provider or mobile network operator. In general, the physical IMEI 212 is manufactured with the device and assigned permanently and uniquely to the device 202. The physical IMEI 212 allows the mobility network to identify valid devices and distinguish between them.

In contrast, a virtual IMEI may be established by the device 202 on demand, such as in response to a user request or in response to operation of an application or artificial intelligence/machine learning function of the device. One virtual IMEI may be nested inside another, in a hierarchical arrangement. The virtual IMEI may have its characteristics defined as a subset of any of the characteristics or functions associated with the physical IMEI 212. Further, the virtual IMEI may be disable or removed at will or when its presence is no longer required.

The physical IMEI enables certain functionality of the device 202. For example, access to the mobility network is accomplished through a registration procedure in which the 15-digit number, or other content of the physical IMEI, is presented to the network for verification. Further, the physical IMEI 212 may be used for accessing and receiving mobile data at the device 202. The device 202 may implement a variety of applications involving capabilities of the device. In one example, a gaming application or app may be downloaded and installed on the device 202 to provide access to online gaming over the mobility network. A user of the device 202 may participate in the game based on the user's identity, as contained in a SIM of the device 202, and the physical IMEI 212. Such apps may be accessed at and downloaded from an application store over a network. The physical IMEI 212 is associated with all capabilities of and functions of the device 202. If an app or voice or data communication require engagement with the network, the physical IMEI 212 is required for registration access to the network.

In accordance with various aspects described herein, one or more virtual International Mobile Equipment Identities (virtual IMEIs) can be created or generated as replicas of the physical IMEI 212. FIG. 2A shows a first virtual IMEI 212a, a second virtual IMEI 212b, and a third virtual IMEI 212c. Any number of virtual IMEIs may be created based on the physical IMEI.

In general, a virtual IMEI may be defined by the 15-digit serial number of the physical IMEI 212. In that regard, the virtual IMEI may be considered a clone or a replica of the physical IMEI. In addition, the virtual IMEI may be defined by a set of capabilities or authorizations that describe, enable or limit how the device 202, or another device, may operate. As noted, the physical IMEI 212 is associated with all capabilities of the device 202 and all functions of the device 202. In accordance with various aspects described herein, a virtual IMEI may be defined to have a subset of the capabilities associated with the physical IMEI 212. Thus, the virtual IMEI as a clone or replica of the physical IMEI 212 may include or be associated with all or less than all of the capabilities of the physical IMEI 212.

In one example, the first virtual IMEI 212a may be defined with the capability to send and receive text messages from the device 202. The texting capability may be applied to all functionalities of the device 202, including a native short message service (SMS) functionality, a texting application, and an application providing additional functionality along with texting ability. The capability of the virtual IMEI 212a may be defined or circumscribed in any way necessary. During the operation of the device 202, operation by an application or other function of the device may send a text message and may designate or select the first virtual IMEI 212a for doing so. On the other hand, if the application seeks to send a video file, that is excluded from the capabilities of the first virtual IMEI 212a and cannot occur. To send the video file, the application either needs to do so using the physical IMEI 212, which has all capabilities, or find a virtual IMEI which has video communication capabilities.

In another example, the second virtual IMEI 212b is defined for or dedicated for video conferencing. The resources of the device 202 that are required for video conferencing may be dedicated and associated with the second virtual IMEI 212b. Such resources, in an example, include a display screen and camera, microphone and speaker, user interface controls, an radio components for reception and transmission. In this manner, all virtual devices are as functional and versatile as physical ones.

In yet another example, the device 202 implements an artificial intelligence/machine learning (AI/ML) function. Examples includes a machine learning model implemented in the memory of the device 202 for performing inferences and developing predictions or recommendations. The processing system that controls operation of the device 202 implements the instructions that form the AI/ML function. In this example, the capabilities or capacity of the AI/ML function are partitioned among users. In the example, the third virtual IMEI 212c is associated with or partitioned to use a portion of the capabilities or capacity of the AI/ML function. The physical IMEI 212 may use all capabilities of the AI/ML function.

In this manner, a virtual version of the device 202 may operate under control or with assistance of an artificial intelligence function, forming an AI powered virtual version 214 of the device 202. Similarly, the device 202 may define virtual tasks associated with a virtual IMEI such as third virtual IMEI 212c. The virtual tasks are limited by the capabilities associated with the third virtual IMEI 212c.

In an example, virtual IMEIs may be associated with other devices instantiated on a local network such as a Wi-Fi network or a Bluetooth network, or even remotely with access through the mobility network. In the example, virtual devices include a smartphone such as smartphone 208, a wearable device such as a watch or fitness tracker, a home assistant, a smart thermostat and an IoT device 210. The user interface 204 of the device 202 may be used to instantiate the virtual IMEIs so that the virtual IMEIs are generated on demand. The demand or request for a new virtual IMEI may originate with the user accessing the user interface 204. Or, the demand or request for a new virtual IMEI may originate with the processing system of the device 202. That is, as part of an on-going process on the device 202, or under control of an application operating on the device 202, the device 202 may generate or instantiate a new virtual IMEI. The request may specify particular capabilities of the new virtual IMEI, such as text communication abilities or voice communication abilities.

In embodiments, a virtual IMEI may be associated with a device operating on a collaborative network 206. For example, if the user's home network includes a smart thermostat, such as a thermostat that includes an IoT device or an AI/ML function, the device 202 may associate the smart thermostat with the thermostat virtual IMEI and define particular characteristics for the virtual IMEI. In particular, the defined characteristics or capabilities of the virtual IMEI may include communication with the smart thermostat over the home network, receiving sensor information from the smart thermostat and generating control data for the smart thermostat. In this manner, the user may use a smartphone user interface portion 218 of the user interface 204 to control the smart thermostat.

In the same way, the device 202 may instantiate a new IMEI to interact with a user wearable device such as a smartwatch. The user may interact with a wearable user interface portion 220 to control the smartwatch. Still further, if the user's home network includes a home assistant, the user may use the user interface 204 to request a home assistant virtual IMEI. The user may use the user interface 204 to specify capabilities of the home assistant virtual IMEI, such as audio communication and internet access over the home network or the public internet. The device 202, acting through the home assistant virtual IMEI, controls the home assistant through a home assistant user interface portion 222. Similarly, another smartphone 208 may be controlled or communicated with by a smartphone user interface portion 224 using a smartphone virtual IMEI designated for the smartphone 208.

As indicated in FIG. 2A, the devices of the collaborative network 206 implement autonomous communication among the devices. Further, the devices may use AI/ML functions such as TinyML model or module to perform functions including decision making. In all cases, the operation of the devices including collaborative operation is under control of and limited by the virtual IMEI assigned to or associated with each device.

A TinyML device is a small, low-power hardware device or software module, typically a microcontroller, which is capable of running machine learning models on-device. Such TinyML devices have very limited computational resources, including processing power, memory, and storage. TinyML devices are generally low-power and are designed to operate on minimal energy, often powered for extended periods. Power consumption is typically in the milliwatt (mW) range or even lower. Further, instead of sending data to the cloud, the device 202 or another device for analysis, TinyML devices perform the machine learning inference (making predictions or classifications) directly on the device itself. Use of TinyML devices provides low latency, power efficiency, privacy and security. Examples of use of TinyML devices include in smart sensors such as may incorporated with IoT device 210, smart home devices and wearable devices, and industrial control and automation.

In some aspect, the system 200 provides the capability for devices to communicate with each other autonomously. Using AI and TinyAI, these devices, such as smartphones, wearables, and home assistants, form a collaborative network 206. For example, a smart thermostat can receive instructions from the user's device 202 to adjust the temperature based on a preset schedule, or a smartwatch can sync with a home assistant to provide personalized health tips. This autonomous communication ensures that all user devices work together harmoniously to meet user needs.

The system 200 is based on a robust architecture that supports interactions between virtual devices and human users. Virtual machines can mimic human-device interactions, enhancing user experience. For instance, the system 200 can detect dangerous activities, such as unauthorized access attempts, and send immediate alerts to ensure user and location security. This architecture provides a strong foundation for seamless and secure virtual device management.

As indicated, AI capabilities may be pre-loaded into physical devices such as the smart thermostat or home assistant. Options may be enabled for over-the-air (OTA) updates to ensure continuous improvement and adaptation. For example, a machine learning model installed on a device may be monitored for performance and, when necessary, an updated model may be installed over the network. After installation, the updated model may be trained, or the existing model may be retrained using more-current training data. Additionally, these AI functionalities can also be locally generated, providing flexibility and customization for users.

To support the collaborative network 206, the system 200 introduces virtual IMEIs. These virtual identifiers allow a single physical device such as device 202 to host multiple virtual devices. For instance, a smartphone can have separate virtual phones for work, for personal use, and for travel. Each virtual phone operates independently, yet all are managed within the user's primary device, device 202, through the user interface 204. This flexibility means the user can activate and deactivate virtual phones as needed, tailoring device usage to specific user requirements.

Architecture and operation of the system 200 differentiates between a physical IMEI (pIMEI) and multiple virtual IMEIs vIMEIs. This differentiation allows the user to activate multiple vIMEIs on demand, providing greater flexibility and scalability in device management. An example is vIMEI system 228 in virtual IMEI 212a for a virtual device. For example, if the user needs an additional virtual phone for a temporary project, the user can easily activate a vIMEI and deactivate it once the project is complete. In examples, a pIMEI can instantiate multiple virtual subscribers. Further, each virtual subscriber can further expand and instantiate more virtual subscribers. Thus, vIMEI subscribers can have multiple layers like a family tree structure. More than one vIMEI can connect and text each other.

In the system 200, virtual IMEIs are designed to expand the functionality of virtual devices. Such virtual IMEIs can send video and text messages, enhancing communication capabilities. The user can define a virtual phone dedicated to video conferencing while another virtual phone manages text communications, all within the same physical device such as device 202. This capability ensures that virtual devices are as functional and versatile as physical ones.

To support the unique needs of virtual devices, the system 200 includes a dedicated application or app store for vIMEIs. This app store is accessible from, for example, an app store application 226 within the device 202 or accessible by a virtual device such as virtual IMEI 212a associated with a virtual device. The app store 226 allows the user to search for, select, download and utilize applications or specific VIMEIs which are specifically designed for virtual devices. Whether the user needs productivity tools, communication apps, or entertainment options, the vIMEI app store ensures that the user's virtual devices have access to the necessary applications. In some embodiments, the vIMEI app store includes a digital currency system, enabling exchanges between physical and digital currencies. This integration ensures seamless transactions across both realms. Further, blockchain technology is utilized in some embodiments to manage and authenticate relationships among family, friends, and relatives within the digital ecosystem. This ensures secure and transparent connections.

As noted, aspects of TinyML are integrated into the system 200 to enable efficient, low-power AI processing. This allows user devices such as device 202 to process data and make decisions in real-time. For example, the user's smartphone or other device 202 can analyze the user's daily routine and suggest optimal times for meetings or remind the user to take breaks. TinyML ensures that devices are always responsive and intelligent, enhancing their usefulness.

In a further aspect, the concept of digital twin is employed to create an AI-powered virtual version of the user's smartphone or other device 202 that can perform tasks simultaneously with the user's physical device. A digital twin in the context of AI and TinyML is a dynamic virtual representation of a physical entity, like a device, sensor, application, or process, which is enhanced with artificial intelligence and often interacts with TinyML devices at the edge. The digital twin generally comprises a software model that mirrors a real-world counterpart. This includes its structure, behavior, and data. The digital twin is connected to the physical device 202 through sensors, IoT devices, and data streams, and receives real-time information about its status and performance. The digital twin is continuously updated with data from the physical device 202, allowing the digital twin to accurately reflect its current state and historical behavior. The digital twin enables simulation of various scenarios, prediction of future behavior, and analysis of performance without directly affecting the physical device 202. In an example, while the user is engaged in a video meeting using the device 202, the digital twin of the user can handle routine operations like checking emails, managing calendar events, or controlling smart home devices. This ensures that the user remains productive without interruptions, as the virtual twin takes care of mundane tasks.

By enabling autonomous communication, efficient AI processing, and versatile virtual device management, the system 200 transforms the way user interact with technology. The system 200 creates a seamless, secure, and intelligent network of devices that work together to enhance the user's daily life, making it more connected, productive, and efficient.

FIG. 2B depicts an illustrative embodiment of a method 230 in accordance with various aspects described herein. The method 230 may be performed in a user device such as the device 202 of FIG. 2A. In example embodiments, the method 230 may be performed in a mobile device or smartphone of an individual user accessing a mobility network such as a 5G cellular, 6G cellular or later network. The method 230 may be initiated in response to user engagement with the device such as by manipulating the user interfaced of the device.

FIG. 2B illustrates method 230 for instantiating and managing virtual device identities within a physical communication device. The process begins with step 232, where a request is received to instantiate a virtual device identity, which corresponds to the user interface 204 in FIG. 2A. The user interface allows users to interact with the device and initiate the creation of virtual identities. The physical communication device, such as a smartphone, includes a physical IMEI for identification of the device when accessing the mobility network and other uses.

In step 234, a virtual IMEI is generated based on the physical IMEI, linking to the physical IMEI 212 in FIG. 2A. The physical IMEI serves as the foundation for creating virtual replicas of the physical IMEI. Step 236 involves associating the vIMEI with a virtual device instance configured to execute a subset of device functionalities, such as those depicted in FIG. 2A, where virtual devices like smartphones 224, wearables 220, and home assistants 222 are part of a collaborative network 206. Step 236 may involve copying or duplicating a 15-digit number which forms the physical IMEI. The copied valued is then stored as part of each virtual IMEI for use by the device, under control of the vIMEI, for accessing the network, network services and applications and other functionalities. In some embodiments, the physical IMEI of the device may be modified so as to be slightly different in form from the physical IMEI yet still convey a relationship to the physical IMEI. For example, each vIMEI may be created by duplicating the 15-digit number of the pIMEI and appending one or more digits or letters thereto for use as the vIMEI.

Step 238 integrates a machine learning module, reflecting for example the AI and TinyML integration 206 in FIG. 2A, which enables real-time decision-making and efficient processing. The AI or ML process, or TinyML, may be downloaded to the device over a network, or activated if already present on the device. In addition, the AI or ML process may be trained or retrained and appropriate training data, or retraining data, may be downloaded so that the AI or ML process is up to date for processing items and inferences in real time.

Finally in this example, at step 240 the method 230 registers the device with a mobility network for autonomous device-to-device communications, facilitating the collaborative network 206 shown in FIG. 2A, where devices communicate and operate autonomously. This sequence of steps in FIG. 2B demonstrates the dynamic management and operation of virtual device identities, enhancing the functionality and flexibility of the physical device as described in the claims.

Accordingly, the device 202 and the method 230 illustrate a solution to the technical problem mentioned above. By creating virtual IMEIs based on a physical IMEI assigned to the device, the device 202 and other embodiments attain a flexibility not previously available to such devices. A new vIMEI can be generated on demand, as needed, by current user activities or other activities of the device. While the physical IMEI is associated with all functionality and capabilities of the device, including voice communications, text communications, data processing and AI/ML functions, the vIMEIs can be associated with only a limited subset of the entire set of capabilities of the device. The association may be selected by the user or by autonomous action of the device. The use of vIMEIs provides an improvement to the technical field of communication devices by enhancing multiprocessing and multimodal operation of the device on conventional networks.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

From the foregoing, it can be seen that the present disclosure provides for the introduction of a virtual IMEI (vIMEI) system that transforms device identification and management by allowing a single physical device to host multiple virtual identities. This system enables on-demand activation and management of multiple vIMEIs, providing remarkable flexibility and scalability in device management. The vIMEI concept extends beyond traditional device identification, incorporating machine learning for efficient, low-power AI processing, which facilitates real-time data processing and decision-making. Additionally, features of the disclosure integrate a dedicated vIMEI application (app) store, offering applications specifically designed for virtual devices, thereby enhancing user experience and functionality. Aspects of the architecture support autonomous device-to-device communication, leveraging AI to form collaborative networks that enhance user interaction and productivity. Furthermore, features of the disclosure employ blockchain technology for secure management of digital relationships and introduces a digital currency exchange system, bridging the gap between physical and digital transactions. This comprehensive approach not only enhances security and communication capabilities but also redefines the interaction between devices and users, creating a seamless, intelligent network of devices.

In view of FIG. 1, FIG. 2A, and FIG. 2B, several alternate embodiments can be considered for the subject disclosure. Some embodiments incorporate advanced security protocols using blockchain technology to authenticate and manage virtual IMEIs, ensuring secure communication between virtual devices and the network, preventing unauthorized access, and enhancing data integrity. Other embodiments dynamically allocate resources among virtual devices based on real-time usage patterns and network conditions, using AI algorithms to predict resource needs and adjust allocations to optimize performance and energy efficiency. Additionally, the system in some embodiments allows virtual IMEIs to be shared or transferred across multiple physical devices within a user's ecosystem, enabling seamless continuity of services and applications as users switch between devices, such as moving from a smartphone to a tablet or wearable.

The system is also extended to integrate with Internet of Things (IoT) devices, allowing virtual IMEIs to manage and control IoT functionalities, thus enabling a unified platform for managing smart home devices, wearables, and other IoT components through a single interface such as the device user interface. Furthermore, virtual IMEIs may be utilized to support augmented reality (AR) and virtual reality (VR) applications, where each virtual identity manages specific aspects of the immersive experience, such as rendering graphics, processing user inputs, or managing network communications for real-time interactions. Users may be provided with the ability to customize virtual IMEIs with specific profiles tailored to different contexts, such as work, travel, or entertainment, with each profile having predefined settings and applications that activate based on the user's location or activity.

In other embodiments, the collaborative network depicted in FIG. 2A is expanded to include external devices and services, allowing virtual IMEIs to interact with third-party applications and cloud services, thereby enabling broader functionality and integration with external ecosystems. Lastly, some embodiments of the system incorporate AI-driven predictive maintenance features that monitor the health and performance of virtual devices, alerting users to potential issues and suggesting optimizations to prolong device lifespan and enhance performance. These alternate embodiments leverage the foundational concepts of virtual IMEIs and TinyML integration to expand the system's capabilities, offering enhanced flexibility, security, and user experience across various applications and environments.

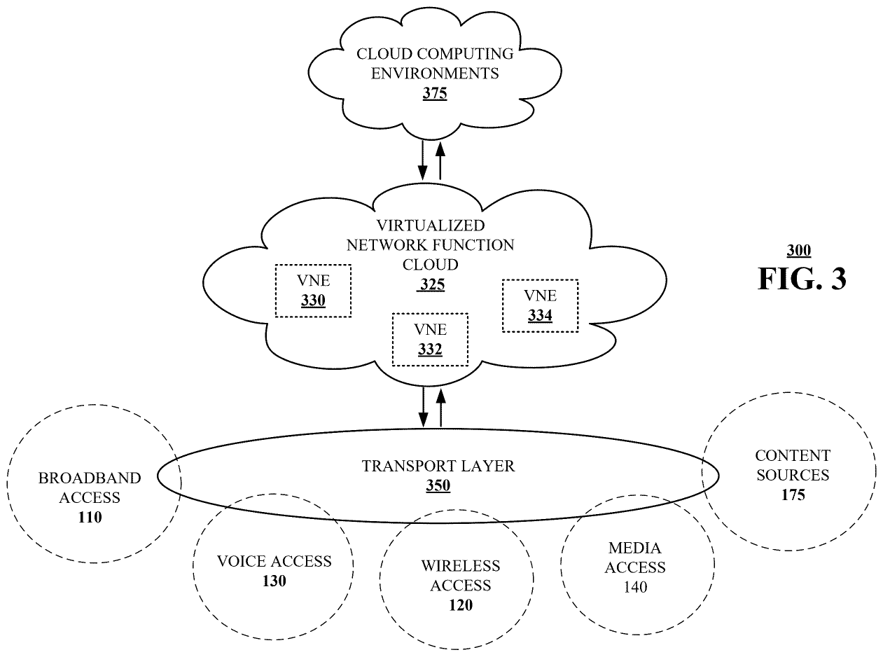

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, and method 230 presented in FIG. 1, FIG. 2A, FIG. 2B, and FIG. 3. For example, virtualized communication network 300 can facilitate in whole or in part creation and management of virtual IMEIs based on a physical IMEI in a device accessing a communications network.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

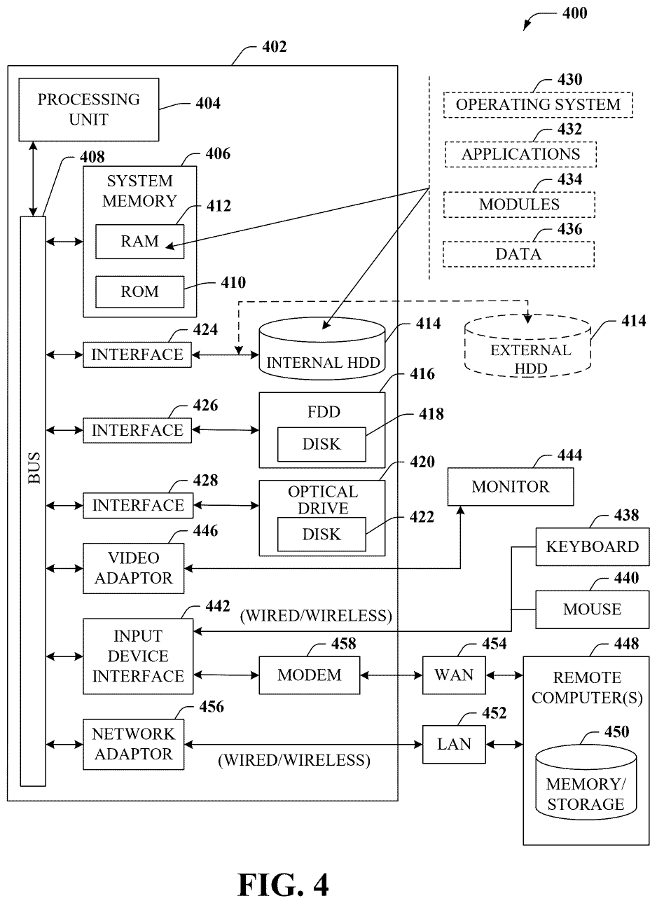

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part creation and management of virtual IMEIs based on a physical IMEI in a device accessing a communications network.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are an example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

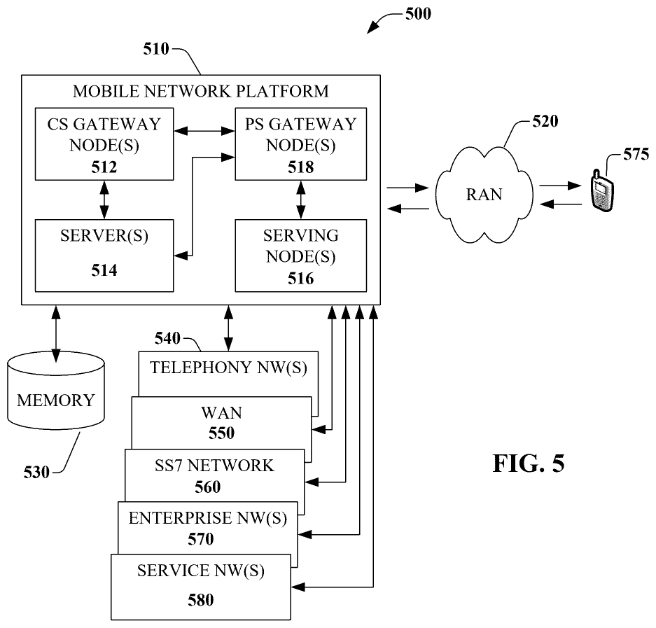

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part creation and management of virtual IMEIs based on a physical IMEI in a device such as radiotelephone 575 accessing a communications network. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated with mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part creation and management of virtual IMEIs based on a physical IMEI in a device such as the communication device 600 accessing a communications network.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth^{®}and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or non-volatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a physical International Mobile Equipment Identity (physical IMEI), wherein the physical IMEI has associated therewith a set of capabilities associated with functions of the device;
a processing system including a processor; and
a memory that stores executable instructions that, when executed by the processing system, facilitate performance of operations, the operations comprising:
creating one or more virtual International Mobile Equipment Identities (virtual IMEIs) as replicas of the physical IMEI, wherein each virtual IMEI of the one or more virtual IMEIs has associated therewith a subset of the set of capabilities associated with functions of the device;
performing at least some of the functions of the device according to the physical IMEI; and
performing at least one of the functions of the device according to a virtual IMEI of the one or more virtual IMEIs.

2. The device of claim 1, wherein the operations further comprise:
providing a user interface at the device;
receiving, at the user interface, an input command to instantiate a virtual IMEI on the device; and
generating a new virtual IMEI on the device, wherein the generating the new virtual IMEI comprises defining identification parameters for the new virtual IMEI matching identification parameters of the physical IMEI and defining capabilities of the set of capabilities to be associated with the virtual IMEI.

3. The device of claim 2, wherein the operations further comprise:
initiating a device function of the device according to the physical IMEI;
initiating a virtual device function of the device according to the new virtual IMEI; and
communicating data between the device function and the virtual device function on the device, wherein the communication is based on the physical IMEI and the new virtual IMEI, and wherein the device function and the virtual device function operate independently on the device.

4. The device of claim 3, wherein the operations further comprise:
initiating the device function of the device by registering with a mobile communications network based on the physical IMEI, forming an authorized device;
communicating data between the authorized device and the mobile communications network based on the registering;
initiating the virtual device function of the device by registering with the mobile communications network based on the new virtual IMEI, forming an authorized virtual device; and
communicating additional data between the authorized virtual device and the mobile communications network.

5. The device of claim 4, wherein the operations further comprise:
communicating first application data between the authorized device and a first networked device over a local communications network; and
communicating second application data between the authorized virtual device and a second networked device over the local communications network.

6. The device of claim 1, wherein the operations further comprise:
generating a first new virtual IMEI on the device, wherein the generating the new virtual IMEI comprises defining first capabilities to be associated with the new virtual IMEI, wherein the first capabilities are a subset of the set of capabilities; and
generating a second new virtual IMEI on the device, wherein the generating the second new virtual IMEI comprises defining second capabilities to be associated with the second new virtual IMEI, wherein the second capabilities are a subset of the first capabilities.

7. The device of claim 1, wherein the operations further comprise:
instantiating a TinyML model on the device for access according to the physical IMEI and access according to the one or more virtual IMEIs.

8. The device of claim 7, wherein the operations further comprise:
identifying capabilities of the TinyML model; and
partitioning the capabilities of the TinyML model among respective device functions associated with the physical IMEI and respective device functions associated with the one or more virtual IMEIs.

9. The device of claim 7, wherein the operations further comprise:
instantiating an application on the device, the application cooperating with an remote application operating on a remote device, wherein the instantiating the application comprises associating the application with a virtual IMEI of the one or more virtual IMEIs; and
communicating with the remote device, wherein the communicating comprises communicating artificial intelligence/machine learning (AI/ML) data of the application and the remote application, wherein the communicating is autonomously under control of the application and the remote application.

10. The device of claim 9, wherein the operations further comprise:
collaborating with the remote device to perform selected operations by the remote device under control of the applications; and
providing collaboration data to the TinyML model for inference generation by the TinyML model;
receiving prediction or classification information from the TinyML model based on the collaboration data; and
controlling the selected operations by the remote device based on the prediction or classification information.

11. A non-transitory machine-readable medium, comprising executable instructions that, when executed by a processing system including a processor, facilitate performance of operations, the operations comprising:
generating, on a physical device, a plurality of virtual device identities, each virtual device identity comprising a virtual international mobile equipment identity (vIMEI) that is matching a physical international mobile equipment identity (pIMEI) of the physical device;
instantiating one or more virtual subscribers, each respective virtual subscriber associated with a respective virtual device identity of the plurality of virtual device identities; and
associating each virtual device identity with a corresponding set of operational parameters, the set of operational parameters associated with a particular task of a virtual subscriber associated with the virtual device identity.

12. The non-transitory machine-readable medium of claim 11, wherein the instantiating one or more virtual subscribers comprises:
instantiating one or more virtual subscribers on the physical device.

13. The non-transitory machine-readable medium of claim 12, wherein the instantiating one or more virtual subscribers comprises:
instantiating a virtual subscriber of the one or more virtual subscribers on a second physical device, the second physical device being different from the physical device;
initiating autonomous communication sessions between a local virtual subscriber on the physical device and a remote virtual subscriber on the second physical device; and
communicating, via a network communication protocol, with the second physical device, wherein the communicating is based on the plurality of virtual device identities to simplify communication and control between the physical device and the second physical device.

14. The non-transitory machine-readable medium of claim 11, wherein the operations further comprise:
receiving, at a user interface of the physical device, an input command to instantiate the one or more virtual subscribers on the physical device; and
generating each respective virtual device identity of the plurality of virtual device identities based on a combination of identification parameters of the physical device and distinct virtual identification data for the one or more virtual subscribers.

15. The non-transitory machine-readable medium of claim 11, wherein the instantiating one or more virtual subscribers comprises:
associating a generated virtual device identity of the plurality of virtual device identities with a set of operational parameters including machine learning instructions to enable the generated virtual device identity to perform the particular task of the virtual subscriber associated with the generated virtual device identity.

16. A method, comprising:
creating, by a processing system including a processor, a plurality of virtual device identities on a physical device, forming generated virtual identities, wherein each virtual device identity comprises a virtual international mobile equipment identity (vIMEI) based on a physical international mobile equipment identity (pIMEI) of the physical device;
receiving, by the processing system, an application specific to a virtual device identity of the plurality of virtual device identities from a dedicated virtual device application store, wherein the application enables performance of specific functions by virtual devices associated with the virtual device identity; and
instantiating a generated virtual identity, wherein the instantiating the generated virtual identity comprises instantiating the generated virtual identity according to the application for performance of the specific functions by the generated virtual identity.

17. The method of claim 16, further comprising:
initiating, by the processing system, an autonomous communication session between virtual device identities of the plurality of virtual device identities and an external device via a network communication protocol; and
instantiating, by the processing system, the generated virtual identity on the external device for performance of the specific functions by the generated virtual identity at the external device.

18. The method of claim 17, wherein the instantiating the generated virtual identity on the external device comprises:
instantiating, by the processing system, a TinyML function on the external device; and
communicating, by the processing system, according to the autonomous communication session, with the TinyML function, wherein the communicating is based on the generated virtual identities.

19. The method of claim 16, comprising:
providing, by the processing system, a user interface;
receiving, by the processing system, at the user interface, an input command selecting the application; and
instantiating, by the processing system, the generated virtual identity with the application.

20. The method of claim 16, comprising:
instantiating, by the processing system, an artificial intelligence process with the generated virtual identity;
receiving, by the processing system, over-the-air updates to the artificial intelligence process; and
updating, by the processing system, the artificial intelligence process according to the over-the-air updates.
